(19) United States
(12) Patent Application Publication
(10) Pub. No.: US 2004/0046281 A1
(43) Pub. Date: Mar. 11, 2004

(54) Localized compression molding process for fabricating microstructures on thermoplastic substrates

(76) Inventors: Byung Kim, Amherst, MA (US); Donggang Yao, Rochester Hills, MI (US)

Correspondence Address: Byung Kim, 23 Woodlot Rd., Amherst, MA, 01002, US

(21) Appl. No.: 10/236,799

(22) Filed: Sep. 6, 2002

(51) Int. Cl. B29C 33/02; B29C 59/02

(52) U.S. Cl. 264/237; 264/404; 264/293; 425/3; 425/407

(57) ABSTRACT

This invention discloses a process for rapidly and economically replicating microstructures on polymeric substrates. During the process, a die with protruded microstructures is rapidly heated to above the polymer softening temperature, pressed onto a cold polymer substrate, and subsequently rapidly cooled for die separation. When the heated die contacts the polymer substrate, localized melting occurs at the contacting locations between the substrate and the to-be-replicated microstructure. The resulted melts are confined locally, forming localized spots for compression molding. Bulk deformation of these localized melts results in microstructure replication. In addition to reduction in cycle time, the new process improves dimensional accuracy of replicated microstructures due to uncoupling of microfabrication with macrofabrication.

### BACKGROUND—STATEMENT REGARDING FEDERALLY SPONSORED RESEARCH OR DEVELOPMENT

Research leading to the invention disclosed and claimed herein was supported in part by the National Science Foundation, NSF Grant No. DMI-9713519. The U.S. Government may have certain rights to the invention.

### CROSS-REFERENCE TO RELATED APPLICATIONS

This invention relates in part to the pending application entitled “Method and Apparatus for Rapid Mold Heating and Cooling,” with inventors Byung Kim and Donggang Yao, filed on Sep. 4, 2002.

### BACKGROUND

1. Field of Invention

The field of the invention pertains to microstructure fabrication using thermoplastic materials, and in particular provides a new micromolding method for rapidly and accurately replicating microstructures on thermoplastic substrates.

In the description of the invention, microstructures are defined as features on a molded article which have characterizing dimension fallen between a tens of one micron to several hundred microns. A thermoplastic material is defined as a material which softens upon heating and hardens again upon cooling, such as thermoplastic polymers.

2. Description of Prior Art

Plastic microstructures are desired in many miniaturized devices. Examples are microfluidic channels, micro titer plates, diffractive gratings, plastic micro heat pipes, high heat convective surfaces of electrical packages, and so forth. Because the production scale in such biomedical, optical and electric packaging applications is very large, lithographic methods and precision engineering methods can only be used for prototyping purpose. The actual volume production requires low-cost mass-production methods.

About ten years ago, investigators from Germany started to develop technology for mass production of polymer-based microstructures, which resulted in a so-called LIGA technology, a German acronym for Lithographie, Galvanoformung, Abformung (lithography, electroplating, molding). In a LIGA process, resist materials such as PMMA are lithographed first; a nickel alloy mold is then formed out of the resist pattern; mass production molding processes, i.e. injection molding, compression molding and photo molding, are finally carried out. A more detailed description of the LIGA process can be found on pages 275 through 359 in Madou's book entitled “Fundamentals of Microfabrication” published by CRC Press LLC in 1997.

Micro injection molding and hot embossing (compression molding) are two micromolding methods currently available for microstructure replication on thermoplastic materials. In a thermoplastic micromolding process, a molten or softened polymeric material is delivered to the die area for deformation or flow under pressure work, solidified under cooling and finally ejected out of the mold. The primary difficulty in molding microstructures is that the molten polymer at the entrance of the microstructure will instantaneously freeze upon contacting the relatively cold mold wall due to rapid thermal diffusion across a very thin section. The problem becomes worse when high-aspect-ratio microstructures are to be replicated. In order to alleviate the freezing problem, the mold temperature has to be raised. For example, in the hot embossing process, the mold temperature is typically set to a temperature slightly above the polymer softening temperature (glass transition temperature for amorphous polymer or melting temperature for crystalline polymer). After the material is embossed on the die pattern, the entire molding including both the die and the part are cooled. Because an elevated mold temperature is employed, the cycle time for hot embossing can be as long as 5 minutes or above. For micro injection molding, investigations also indicated that elevated mold temperatures are needed for good replication of microstructures. Despa, Kelly and Collier in their article, “Injection molding high aspect ratio microstructures using mold inserts produced by LIGA techniques”, Pages 286 through 294, SPE, 1998, reported that for HDPE a mold temperature above the melting point of HDPE favors the complete penetration into microvoids, preventing the melt from prematurely freezing. Wimberger-Friedl in his article, “Injection molding of sub-μm grating optical elements”, Pages 78 though 83, Journal of Injection Molding Technology, 2000, reported that, for good replication of sub-μm grating optical elements using polycarbonate, a mold temperature above the glass transition temperature of polycarbonate is needed.

Another drawback in micro injection molding and hot embossing is that microfabrication is coupled with macrofabrication. In both micro injection molding and hot embossing, the plastic material is heated to above its softening or melting temperature. The softened plastic material is then forced to flow under pressure. Because the softened plastic material flows in a cavity comprising both microstructures and macrostructures, a process like this is subjected to flow racing and error propagation. First, there is flow hesitation occurring at the entrance of microstructures. When polymer melt flows into a cavity of variable thickness, it is inclined to fill thick and less resistant areas. Microstructures are frequently built on a thick substrate for assembly and alignment purpose. As a result, great flow imbalance exists in the mold cavity, and the flow stagnates at the entrance of the microstructure until the much thicker substrate is fully filled. The stagnated polymer with zero pressure is vulnerable to entrapment of air voids or impurities, which is disastrous to a tiny feature like microstructures. The second effect of coupled microfabrication and macrofabrication is that any error during substrate molding will be propagated to the microstructure. A very small variation of the substrate dimension due to process variation will become a huge error for the microstructure to align and function in the assembly stage.

An approach to reduce cycle time is to rapidly heat and cool the tool. Since repeatedly heating and cooling a relatively massive mold requires considerable time and energy, means of heating only the mold surface are desired. This approach has been exemplified in the prior arts as disclosed in U.S. Pat. No. 2,979,773, No. 2,984,887, No. 3,671,168, No. 3,763,293, No. 4,201,742, No. 4,340,551, No. 4,390,485, 4,548,773, 5,041,247, and No. 5,762,972. Particularly, our pending patent application entitled “Method and Apparatus for Rapid Mold Heating and Cooling,” filed on Sep. 4, 2002, disclosed a rapid heating and cooling method using radio frequency or high frequency proximity heating. The mold surface with proximity heating can be rapidly heated from room temperature to above the softening temperature of the molding material and then cooled rapidly within normal molding cycle time.

In addition to reduction of cycle time, a means of uncoupling the microstructure molding stage and the substrate molding stage is needed. The microstructure molded in an uncoupled process does not suffer from error propagation from the substrate molding stage.

### SUMMARY OF THE INVENTION

The invention disclosed in this application provides a method for economically and accurately replicating microstructures on thermoplastics-based substrates by integrating rapid heating and cooling techniques with judicious polymer processing strategies. The new technology, called localized compression molding, uses a cold thermoplastic substrate as a starting material, instead of a molten or softened material used in hot embossing and micro injection molding. During the process, the molding die with protruded microstructures is rapidly heated by the proximity heating method or other rapid heating methods. The heated die is then pressurized on the cold substrate, causing localized melting at contacting locations between the microstructure and the substrate. The resulting melts are confined locally, forming localized spots for compression molding. The bulk of the substrate material stays rigid and does not participate in the deformation. Therefore, the microstructure molding process is uncoupled from the substrate manufacturing stage. The heated temperature is maintained during the entire filling stage so that extremely high aspect ratio can be filled. After the microstructure is locally replicated, the die is rapidly cooled for demolding.

The invention provides a solution to the difficulty currently encountered in mass-producing high-aspect-ratio microchannels, which are widely desired in miniaturized applications in medical technology, biotechnology and optical communication. Example applications of microchannels are microfluidic channels, micro titer plates, diffractive gratings, optical wave-guides, micro heat pipes, and so forth.

The invention provides a micro molding method that not only vastly reduce the long cycle time in existing micromolding processes, but it also greatly improve quality and dimensional accuracy of replicated microchannels due to uncoupling of microfabrication from macrofabrication. When the substrate and the microchannel are molded at the same time, as what it is in other micromolding processes, any error or dimensional change of the substrate, which is deemed to be minor for macro applications, will be disastrous to the assembly and alignment of the microchannel. The localized compression molding process does not change the shape and dimension of the substrate during the molding stage of microchannels, thus eliminating coupling effects.

### OBJECTS AND ADVANTAGES

Accordingly, several objectives of this invention are:

An objective of this invention is to provide a method and apparatus for accurately and economically replicating microstructures, especially microchannels, on thermoplastic substrates.

Another objective of this invention is to provide a method to shorten the cycle time in molding microstructures.

A further objective of this invention is to provide a micro molding process in which the microstructure molding stage is uncoupled from the substrate molding stage.

Further objects and advantages of this invention will become apparent from a consideration of the drawings and ensuing description.

### DESCRIPTION OF THE DRAWINGS

The subject matter which is regarded as the invention is particularly pointed out and distinctly claimed in the concluding portion of the specification. The invention, however, may be best understood by reference to the following description taken in conjunction with the accompanying drawing figures in which:

FIG. 1 schematically illustrates several stages involved in the localized compression molding process.

FIG. 2 illustrates the benefit of uncoupling the micromolding stage from the substrate manufacturing stage.

FIG. 3 shows a schematic setup for localized compression molding.

FIG. 4 shows the principle of proximity heating.

FIG. 5 shows the cross section of a set of compression dies using the proximity heating method.

FIG. 6 shows a modified die design with localized rapid heating.

### DESCRIPTION OF THE INVENTION

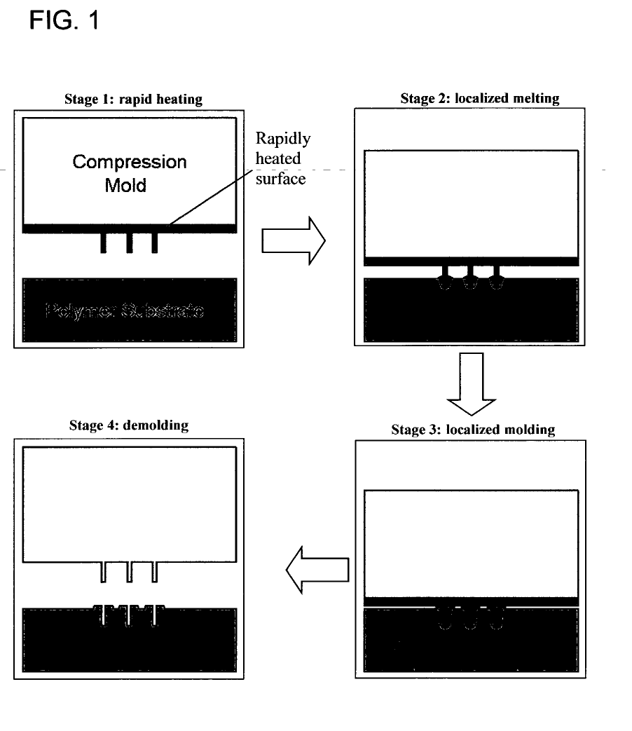

FIG. 1 schematically illustrates several stages involved in the localized compression molding process. In stage one, the surface portion of a compression die with protruded microstructures is rapidly heated to above the softening temperature of the polymer substrate. In stage two, the heated microstructure is pressed on the substrate, locally melting the polymer that contacts with the microstructure. In the third stage, the compression die moves to a full stop, compression molding the microchannel together with some polymer flashes at the die-to-substrate interface. Because a very tiny amount of material is subjected to melting and deformation, melting and molding are carried out at almost the same time. Finally in stage four, the heated surface portion of the die is rapidly cooled for die separation.

From the above description, it can be seen that the localized compression molding process is essentially different from hot embossing and micro injection molding in which the entire molding material is heated to above the softening temperature of the material.

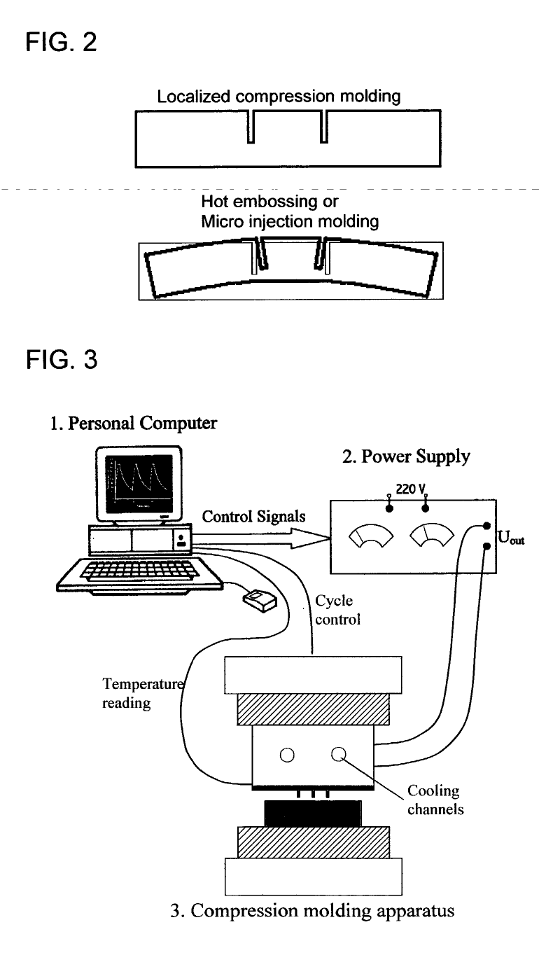

In the localized compression molding process, the substrate, which is much thicker and larger than the microstructure, is mass-produced by a separate manufacturing process beforehand. During localized compression molding, the bulk of the substrate stays cold and does not participate in the deformation. The outside dimension and flatness of the substrate, therefore, is not subjected to any molding-related dimensional changes. The benefit of uncoupling the micromolding stage from the substrate manufacturing stage is illustrated in FIG. 2. Different from localized compression molding, the existing micromolding technology produces both the substrate and the microstructure in the same molding cycle. Due to shrinkage and non-uniform cooling, the shape of the molded substrate is subjected to shrinkage and distortion, as shown in the lower half of FIG. 2. Such distortion, which might be acceptable for macro applications, will be disastrous to alignment and assembly of the molded microstructure.

FIG. 3 shows a schematic setup for localized compression molding. A computerized data acquisition system is used to synchronize the heating cycle with the molding cycle. The heating power is turned on when a new operation cycle begins. When the desired mold surface temperature is reached, the upper platen starts to move downward. At the same time, the heating stage changes to a soaking stage, i.e., maintaining the heated temperature during the period of local melting and molding. After a programmed period for the molding stage elapses, the heating power is switched off and cooling starts. Finally, the upper platen moves upward to demold the part after a programmed cooling time finishes.

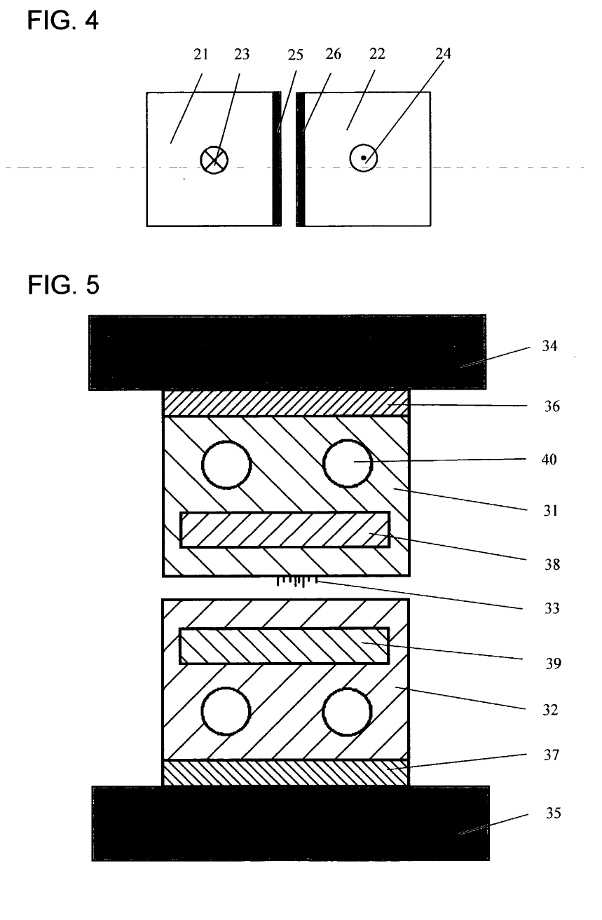

To carry out the localized compression molding process, a compression die with rapid heating and cooling capability is needed. Generally, any method that can deliver such rapid thermal response and can thermo-mechanically endure long cycles can be used. Particularly, the proximity heating method for rapid mold heating which is disclosed in our pending patent application entitled “Method and Apparatus for Rapid Mold Heating and Cooling,” filed on Sep. 4, 2002, satisfies such requirement. The principle for proximity heating is schematically illustrated in FIG. 4. Two metal blocks or bars 21 and 22 face each other with a gap in-between. High-frequency or radio-frequency electric current 23 and 24 is connected to the two bars and flow in opposite directions. Due to the proximity effect, the current will flow on the inner surface or skin of the metal blocks 21 and 22 and form a layer of skin current 25 and 26. The resulting surface current generates electric heating at the surface.

FIG. 5 shows the cross section of a set of compression dies using the proximity heating method. A pair of metallic die inserts 31 and 32 face each other and form a radio-frequency or high-frequency electric circuit. The material for each insert can be any commonly used metals, with preferred choice among ferrous or magnetic metals. Each insert can comprise more than one metallic material, joined together by common mechanical joining processes, or accumulating on each other by surface technology such as deposition, coating, plating, etc. During the heating stage, the upper die comes down and forms a gap between the two inserts. The size of the gap between 31 and 32 during the heating stage is in the range of a fraction of a millimeter to tens of millimeters. The surface contour of the so-formed cavity is not limited to straight shapes, and can be general contours as long as a gap is formed between the mating inserts. Protruded microstructures 33 can be manufactured on one surface or both facing surfaces. Two insulation pieces 36 and 37 provide electric insulation between the two inserts and the mounting bases 34 and 35. The materials for 36 and 37 can be commonly used high-strength and high-stiffness insulation materials with low magnetic permeability such as ceramics, composites, glass, etc., can be an insulation coating on the mold insert, can be an oxidation or nitride layer on the metal surface, etc. Due to proximate effect, the current will flow on the surface of the cavity and generate electric heating on the cavity surface. Thermal insulations 38 and 39 are used to increase heating efficiency and avoid significant heating energy to sink into the mold base during heating. The design of the insulation function by 38 and 39 should be optimized, because too much insulation will result in a prolonged cycle time. Insulations 38 and 39 can be common high-strength and high-stiffness insulation materials such as ceramics, can be air gaps/pockets, or can be gradient materials that have gradient thermal properties on the direction perpendicular to the cavity surface. Cooling channels 40 is built inside the die. To increase the cooling rate at the die surface, the cooling channels can be conformably designed right beneath the die surface.

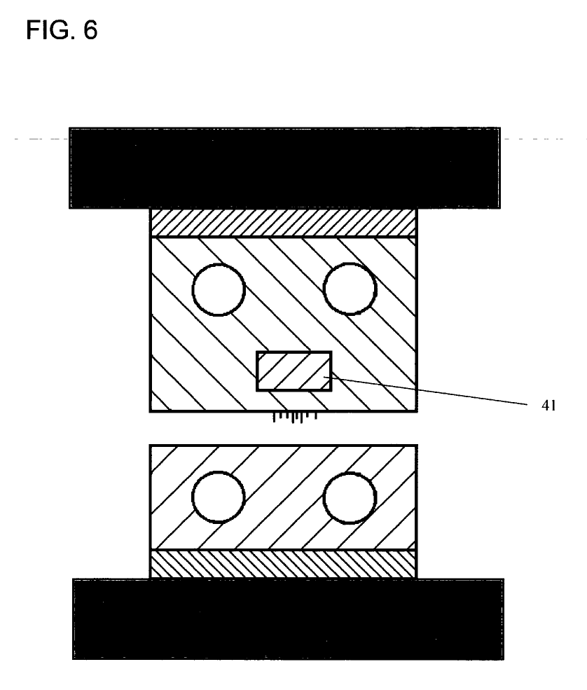

There are many modifications possible in the above die design involving proximity heating. In the case the microstructure is located only on the upper die, the thermal insulation piece 39 should be remove in the lower die to avoid much temperature rise at the surface of the lower die. In addition, heating is only needed in local areas where microstructures are to be molded. A modified die design with localized rapid heating is shown in FIG. 6. The thermal insulation piece 41 is installed locally beneath the microstructure. Therefore, only the microstructure areas will be rapidly heated during the heating stage. Localized rapid heating is advantageous in maintaining a cold temperature at the bulk material of the substrate, thus uncoupling the microstructure molding stage from the substrate molding stage. A locally heated die also helps reduce flashes at the substrate surface. Further modifications of the design are possible. For example, the conformable cooling channels beneath the die surface can also be used as air insulation during the heating stage. To achieve that, the coolant inside the cooling channel is air displaced or vacuumed out before the heating. After the heating stage, the coolant is switch on again for cooling.

### CONCLUSION RAMIFICATIONS AND SCOPE

The invention discloses a process for rapidly and economically replicating microstructures on polymeric substrates. During the process, a die with protruded microstructures is rapidly heated to above the polymer softening temperature, pressed onto a cold polymer substrate, and subsequently rapidly cooled for die separation. When the heated die contacts the polymer substrate, localized melting occurs at the contacting locations between the substrate and the to-be-replicated microstructure. The resulting melts are confined locally, forming localized spots for compression molding. Bulk deformation of these localized melts results in microstructure replication. In addition to reduction in cycle time, the new process improves dimensional accuracy of replicated microstructures due to uncoupling of microfabrication from macrofabrication.

While the above description contains many specificities these should not be construed as limitations on the scope of the invention, but rather as an exemplification of one preferred embodiment thereof. Many other variations are possible. Accordingly, the scope of the invention should be determined not by the embodiments illustrated, but by the appended claims and their legal equivalents.

What is claimed is:

1. A method for compression molding microstructures comprising the steps of:
a) placing a substrate between the two halves of the mold
b) rapidly heating at least a portion of the mold which has microfeatures to a predetermined temperature
c) compressing the heated or being heated microfeatures of the mold into the substrate
d) rapidly cooling the mold, opening the mold and removing a molded article.
whereby heating only the local area where microfeatures are to be molded reduces cycle time and provides dimensional stability due to non participation of the rest of the bulk material in the deformation process.

2. The method of claim 1 wherein said heating comprising the steps of:
a) passing a substantially high frequency alternating electric current through a portion of said mold half
b) passing the current through the other mold half
thereby heating selective surface areas of the mold by said proximity effect to a predetermined temperature.

3. The method of claim 1 wherein said cooling is accomplished by passing a cooling medium to a portion of said mold.

4. The method of claim 3 wherein said cooling is accomplished rapidly by:
passing a cooling medium through a micro channel network that is located on the order of one millimeter below the inner surface of the molds
whereby a rapid cooling reduces the cooling time of the molding cycle.

5. The method of claim 4 wherein the cooling medium is displaced before the heating cycle begins,
whereby avoiding the heating of the cooling medium during the heating phase reduces the heating time and energy.

6. The method of claim 5 wherein the cooling medium is displaced by the pressure gradient of a gas.

7. The method of claim 6 wherein the displacing gas is air.

8. The method of claim 2 wherein the substantially high frequency alternating electric current is between 50 Hz to 100 MHz.

9. An apparatus of mold for compression molding objects, comprising:
a) means for providing insulation layers that electrically isolates said portion of mold halves from the rest of the machine and allowing the magnetic flux generated by said current to pass through said insulation layers
b) means for providing electrical connections from a high frequency power supply to said portion of mold half and then to a portion of the other mold half and back to the high frequency power supply.

10. The mold of claim 9 wherein said portion of the mold is made of materials with a selective magnetic permeability to achieve a selective said skin layer thickness.

11. The mold of claim 9 wherein said portion of the mold is placed in juxtaposition with magnetic materials such as magnetic core to confine the skin thickness.

12. The mold of claim 9 wherein said portion of the mold has thermal insulation whereby said thermal insulation provides energy efficiency in heating said portion of mold surface.

13. The mold of claim 12 wherein said thermal insulation is comprised of any combination of metal oxide layer, polymeric materials, or porous materials.

14. The mold of claim 12 wherein said metal oxide layer is Zirconium Oxide.

15. The mold of claim 12 wherein said thermal insulation consist of air gap and ribs to support the mechanical load and minimize the deflection between the ribs.

16. The mold of claim 12 wherein the cooling channel is placed within said mold.

17. The mold of claim 12 wherein the cooling channels are located near the back of the surfaces of said mold
whereby said cooling channels conforming to the cavity aids uniform cooling.

18. The mold of claim 17 wherein the size of cooling channel gap, the ribs between the channels, and the thickness of the mold surface are between 0.05 mm to 20 mm.

19. The mold of claim 9 wherein a parasitic induction coil is attached for the purpose of increasing the inductance.
